(19) United States
(12) Patent Application Publication
(10) Pub. No.: US 2026/0095690 A1
(43) Pub. Date: Apr. 2, 2026

(54) WEARABLE ELECTRONIC DEVICE

(71) Applicant: Samsung Electronics Co., Ltd., Suwon-si (KR)

(72) Inventors: Kyuho LEE, Suwon-si (KR); Myeounghyeoun DO, Suwon-si (KR); Youngjin OH, Suwon-si (KR); Juntaek OH, Suwon-si (KR); Yerim LEE, Suwon-si (KR)

(21) Appl. No.: 19/410,644

(22) Filed: Dec. 5, 2025

Related U.S. Application Data
(63) Continuation of application No. PCT/KR2024/007327, filed on May 29, 2024.

(30) Foreign Application Priority Data
Jun. 16, 2023 (KR) 10-2023-0077350
Aug. 7, 2023 (KR) 10-2023-0102733

(51) Int. Cl. H04R 1/10; H01Q 1/27

(52) U.S. Cl. CPC H04R 1/1075; H01Q 1/273; H04R 1/1016; H04R 2420/07

(57) ABSTRACT

A wearable electronic device is provided. The wearable electronic device includes a housing, an antenna configured to transmit or receive a signal from the outside of the housing, a battery arranged inside the housing and spaced apart from the antenna, a speaker arranged inside the housing and spaced apart from the antenna, a first substrate electrically connected to the antenna, a second substrate that extends from a first portion connected to the first substrate so as to be connected to the speaker or the battery, and includes a second portion formed at a position extending from the first portion, a first ground structure arranged on the first portion of the second substrate, and a second ground structure arranged on the second portion of the second substrate.

### CROSS-REFERENCE TO RELATED APPLICATION(S)

This application is a continuation application, claiming priority under 35 U.S.C. § 365(c), of an International application No. PCT/KR2024/007327, filed on May 29, 2024, which is based on and claims the benefit of a Korean patent application number 10-2023-0077350, filed on Jun. 16, 2023, in the Korean Intellectual Property Office, and of a Korean patent application number 10-2023-0102733, filed on Aug. 7, 2023, in the Korean Intellectual Property Office, the disclosure of each of which is incorporated by reference herein in its entirety.

### BACKGROUND

### 1. Field

The disclosure relates to a wearable electronic device. More particularly, the disclosure relates to a wearable electronic device including a ground structure.

### 2. Description of Related Art

With the development of electronic technology, various types of wearable electronic devices are required to be downsized and equipped with various functions. To meet this demand, various electronic components are mounted on printed circuit boards (PCBs).

At least one component related to sound effects may be mounted on the printed circuit board of the wearable electronic device. The components related to sound effects may include, e.g., a speaker and a microphone, and these components may be mounted in various shapes and arrangements inside the housing of the wearable electronic device in response to the exterior design of the wearable electronic device that is designed in various ways.

The wearable electronic device in which the speaker and microphone are mounted may be, e.g., an earphone (or earset, headphone, headset), or a hearing aid. The wearable electronic device may be worn on a portion close to the user's ear, and may be manufactured in a compact size for this purpose. The wearable electronic device may be a wireless type including an antenna configured to transmit or receive a signal with an external electronic device. The wearable electronic device may be a wired type including a cable connected to an external electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device including a ground structure.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a housing, an antenna configured to transmit or receive a signal outside the housing, a battery disposed inside the housing and spaced apart from the antenna, a speaker disposed inside the housing and spaced apart from the antenna, a first substrate electrically connected to the antenna, a second substrate extending from a first portion connected to the first substrate and connected to the speaker or the battery, and including a second portion formed at a position extending from the first portion, a first ground structure disposed at the first portion of the second substrate, and a second ground structure disposed at the second portion of the second substrate.

In accordance with another aspect of the disclosure, a wearable electronic device is provided. The wearable electronic device includes a housing, an antenna configured to transmit or receive a signal outside the housing, a microphone disposed inside the housing and spaced apart from the antenna, a first substrate electrically connected to the antenna, a second substrate extending from a first portion connected to the first substrate, and having a second portion connected to the microphone formed at a position extending from the first portion, a first ground structure disposed at the first portion of the second substrate, and a second ground structure disposed at the second portion of the second substrate.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an audio module, according to an embodiment of the disclosure;

FIGS. 3A, 3B and 3C are views illustrating an appearance of a wearable electronic device according to an embodiment of the disclosure;

FIG. 4 is a view illustrating an internal structure of a housing of a wearable electronic device according to an embodiment of the disclosure;

FIG. 5 is a view illustrating a second substrate developed according to an embodiment of the disclosure;

FIG. 6A is a portion of a cross-sectional view illustrating a wearable electronic device according to an embodiment of the disclosure;

FIG. 6B is a portion of a cross-sectional view illustrating a wearable electronic device according to an embodiment of the disclosure;

FIG. 7 is a view illustrating an internal structure of a housing of a wearable electronic device according to an embodiment of the disclosure;

FIG. 8 is a view illustrating a second substrate developed according to an embodiment of the disclosure;

FIG. 9 is a view illustrating a battery viewed from one side according to an embodiment of the disclosure;

FIG. 10 is a view illustrating a battery viewed from one side according to an embodiment of the disclosure;

FIG. 11 is a view illustrating an internal structure of a housing of a wearable electronic device according to an embodiment of the disclosure;

FIG. 12 is a view illustrating a second substrate developed according to an embodiment of the disclosure; and

FIG. 13 is a graph comparing antenna performance of a wearable electronic device with a comparative example according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

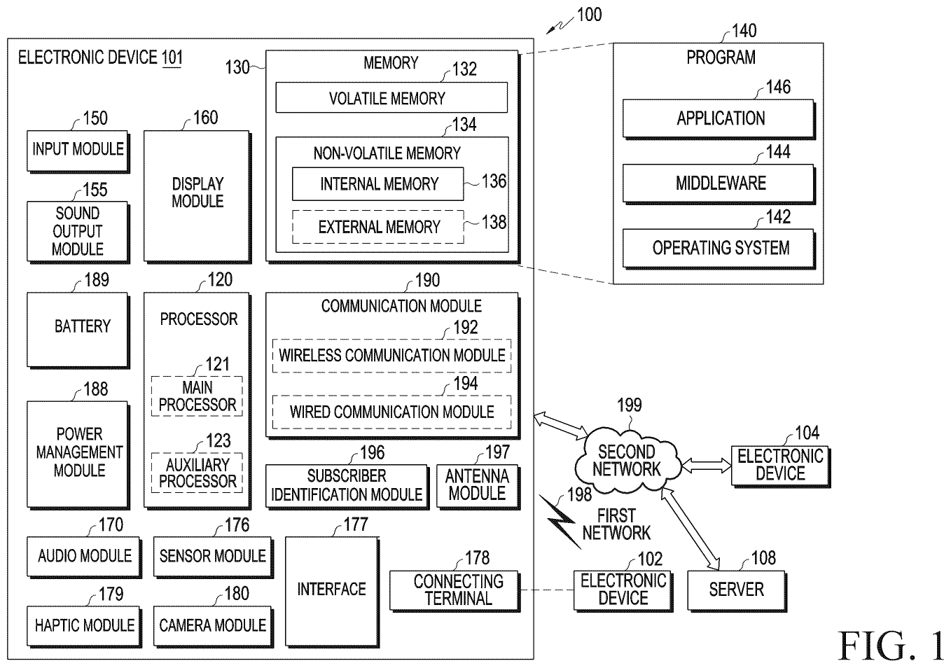

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module may include an antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

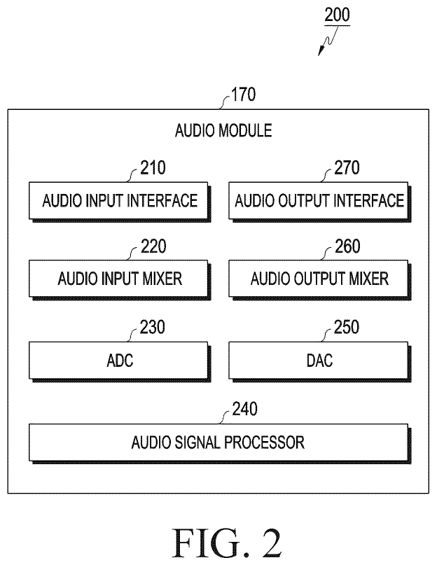

FIG. 2 is a block diagram illustrating the audio module according to an embodiment of the disclosure.

Referring to FIG. 2, in a block diagram 200, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor (120) or the memory (130)) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

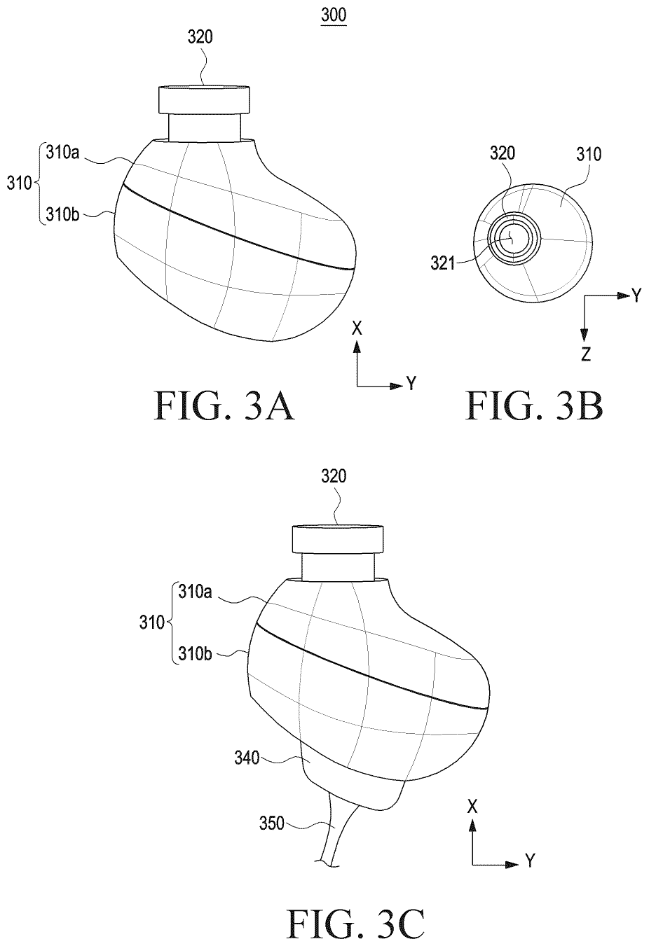

FIGS. 3A, 3B and 3C are views illustrating a cross-section of a wearable electronic device (e.g., the electronic device 101 of FIG. 1) according to an embodiment of the disclosure.

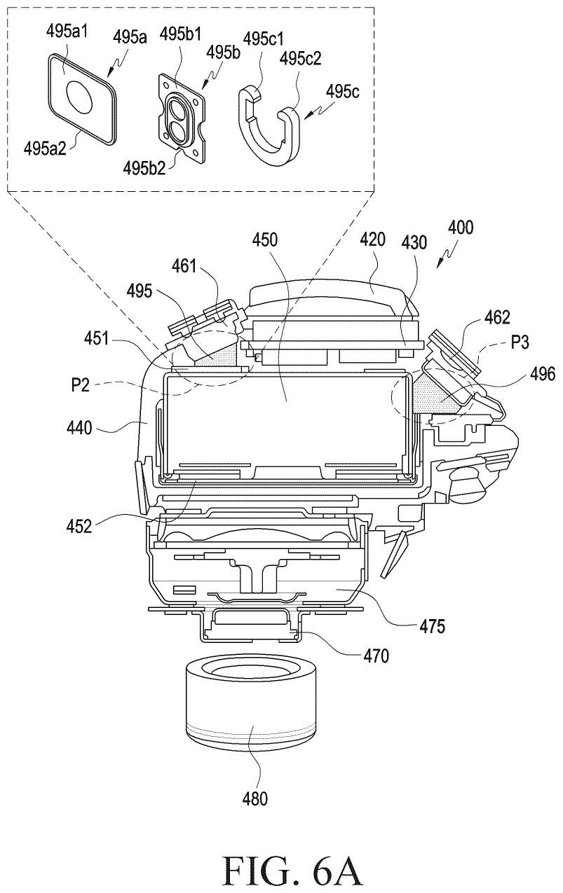

Referring to FIG. 3A, a wearable electronic device 300 according to various embodiments of the disclosure viewed from the side is illustrated. Referring to FIG. 3B, the wearable electronic device 300 according to various embodiments of the disclosure viewed from the top is illustrated. Referring to FIG. 3C, a view including a wired cable 350 connected to the wearable electronic device 300 according to the embodiment illustrated in FIG. 3A is illustrated. The wearable electronic device 300 according to an embodiment of the disclosure may be a wireless type including an antenna (e.g., the antenna 420 of FIG. 6A) configured to transmit or receive a signal outside a housing 310. The wearable electronic device 300 according to an embodiment of the disclosure may be a wired type including a cable 350 connected to an external electronic device (not illustrated) outside a housing 310.

Referring to FIGS. 3A-3C, a directional component X, a directional component Y, and a directional component Z are illustrated. The directional component X, the directional component Y, and the directional component Z are orthogonal to each other and may form a spatial coordinate system defined by an X-axis, a Y-axis, and a Z-axis. The directional component X may represent a height direction of the wearable electronic device 300, the directional component Y may represent a width direction of the wearable electronic device 300, and the directional component Z may represent a length direction of the wearable electronic device 300. Meanwhile, according to various embodiments of the disclosure, the directional component X may indicate a movement path of sound emitted from a speaker.

Referring to FIGS. 3A-3C, the wearable electronic device 300 (e.g., 101 of FIG. 1) according to various embodiments of the disclosure may include a housing 310 and a protrusion 320. The housing 310 may be a single one which combines an upper housing 310a and a lower housing 310b and may have an internal space for receiving various components. For example, acoustic components (e.g., a speaker or a microphone) and electronic components (e.g., a battery, a power management module, a wireless communication module) may be disposed inside the housing 310.

According to an embodiment, as illustrated in FIG. 3B, the wearable electronic device 300 may have an asymmetric shape. The reason why the wearable electronic device 300 is formed to have an asymmetric shape is partly due to consideration of ergonomic factors, but arrangement relationships between acoustic components and electronic components inside the housing 310 may be primarily considered in terms of securing acoustic performance.

The wearable electronic device 300 according to various embodiments of the disclosure may correspond to a device wearable on a portion of a body, e.g., an ear or a head. Examples of the wearable electronic device 300 may include an in-ear earset (or an in-ear headset) and a hearing aid, and may also include various product groups in which a speaker or a microphone is mounted.

In various drawings of the disclosure, as an example of the wearable electronic device 300, a kernel type in-ear earset mounted in an ear canal leading from an auricle to an eardrum may be mainly described. However, it should be noted that the disclosure is not limited thereto. According to another embodiment, although not illustrated in the drawings, the wearable electronic device 300 may target an open type earset mounted on an auricle.

Referring to FIGS. 3A and 3C together, the wearable electronic device 300 (e.g., 101 of FIG. 1) may be integrated into an electronic device (e.g., 102 of FIG. 1), or may be configured separately from an electronic device (e.g., 102 of FIG. 1). The electronic device (e.g., 102 of FIG. 1) may correspond to various types of devices. The electronic device (e.g., 102 of FIG. 1) may include, e.g., a smartphone, a mobile phone, a navigation device, a game console, a TV, a vehicle head unit, a notebook computer, a laptop computer, a tablet computer, a personal media player (PMP), personal digital assistants (PDA), a portable communication device, a computer device, a portable multimedia device, a portable medical device, a camera, a wearable device, or various home appliances. According to an embodiment of the disclosure, the electronic devices are not limited to those described above.

The wearable electronic device 300 may be wiredly or wirelessly connected to an electronic device (e.g., 102 of FIG. 1). In this case, the wearable electronic device 300 may serve as an audio output interface (or a sound output device (e.g., 155 of FIG. 1)) that outputs a sound signal generated in the electronic device (e.g., 102 of FIG. 1) to the outside in relation to the electronic device (e.g., 102 of FIG. 1). Further or alternatively, the wearable electronic device 300 disclosed in the disclosure may also serve as an audio input interface (or an input device (e.g., 150 of FIG. 1)) for receiving an audio signal corresponding to sound obtained from outside the electronic device (e.g., 102 of FIG. 1).

Hereinafter, the wearable electronic device 300 being provided separately from an electronic device (e.g., 102 of FIG. 1) may be described as one example. Accordingly, in the following embodiments, an electronic device (e.g., 102 of FIG. 1) may be referred to as ‘an external electronic device (e.g., 102 of FIG. 1)’ in the sense that it may be provided separately from the wearable electronic device 300. Referring to FIG. 3C, the wearable electronic device 300 may be wiredly connected to an external electronic device (e.g., 102 of FIG. 1). In this case, the wearable electronic device 300 may communicate with an external electronic device using a cable 350. As another embodiment from FIG. 3A, the wearable electronic device 300 may be additionally provided with a connection portion 340 for connection of the cable 350. According to an embodiment, one end of the cable 350 may be connected to the wearable electronic device 300, and the other end of the cable 350 may be connected to a connecting terminal (not illustrated) formed in an external electronic device. Thereby, an electronic device outside the wearable electronic device 300 may be directly connected.

When the wearable electronic device 300 is wirelessly connected to an external electronic device (e.g., 102 of FIG. 1) (e.g., FIG. 3A), the wearable electronic device 300 may communicate with an external electronic device through a network (e.g., a short-range wireless communication network or a long-range wireless communication network). The network may be, but is not limited to, a mobile or cellular communication network, a local area network (LAN) (e.g., Bluetooth communication), a wireless local area network (WLAN), a wide area network (WAN), the Internet, a small area network (SAN), etc.

The wearable electronic device 300 may include a communication module. According to various embodiments, the wearable electronic device 300 may further include at least one of a power management module, a sensor module, a battery, and an antenna module. In an embodiment where the wearable electronic device 300 is wirelessly connected to an external electronic device, the communication module may correspond to a wireless communication module. Further, the wearable electronic device 300 according to various embodiments may further include an audio module (e.g., 170 of FIG. 1) in addition to the components according to the above-described embodiment, and may be integrated in a compact structure inside a housing 310 of the wearable electronic device 300. The audio module (e.g., 170 of FIG. 1) may include, e.g., an audio input mixer (e.g., 220 of FIG. 2), an analog to digital converter (ADC) (e.g., 230 of FIG. 2), an audio signal processor (e.g., 240 of FIG. 2), a digital to analog converter (DAC) (e.g., 250 of FIG. 2), and an audio output mixer (e.g., 260 of FIG. 2). Description of each configuration of the audio module included in the wearable electronic device 300 is omitted in the range overlapping with the embodiment described above in FIG. 2.

According to an embodiment, the wearable electronic device 300 may not communicate with an external electronic device. In this case, the wearable electronic device 300 is not controlled through an external electronic device, and may be implemented to receive a signal corresponding to sound obtained from the outside and output a sound signal to the outside according to operations (or control) of components included in the wearable electronic device 300 themselves. For example, the wearable electronic device 300 may be a stand-alone type electronic device that plays music or video by itself without communicating with an external electronic device, and outputs sound accordingly or receives and processes a user's voice.

According to another embodiment, the wearable electronic device 300 may communicate and/or be controlled with an external electronic device. The wearable electronic device 300 may be an interaction type electronic device that is paired with an external electronic device such as a smartphone through a communication method such as Bluetooth, converts data received from the external electronic device to output sound, or receives a user's voice and transmits it to the external electronic device.

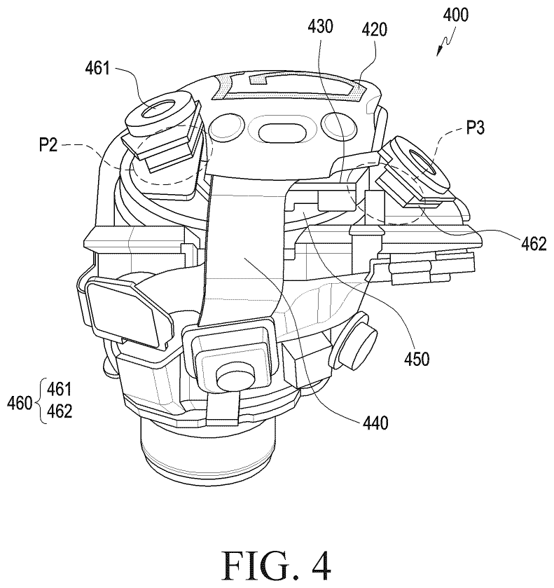

FIG. 4 is a view illustrating an internal structure of a housing (e.g., the housing 310 of FIG. 3) of a wearable electronic device according to an embodiment of the disclosure.

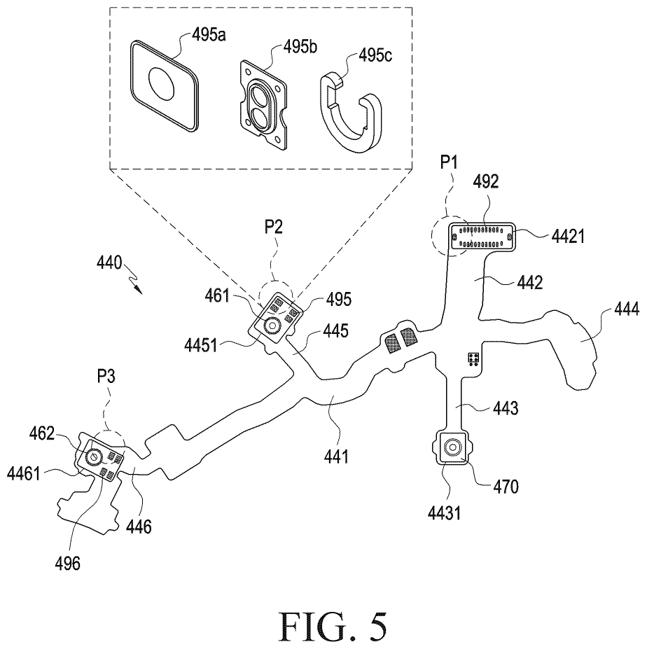

Components described with reference to FIG. 4 may be identical in whole or part to components described with reference to FIGS. 1 to 3. Some or all of the components described with reference to FIG. 4 may be the same as all or some of the components described with reference to FIGS. 5, 6A, 6B, and 7 to 13.

Referring to FIG. 4, the wearable electronic device 400 may include an antenna 420. The antenna 420 may receive a signal outside a housing (e.g., the housing 310 of FIG. 3). The antenna 420 may transmit a signal outside a housing (e.g., the housing 310 of FIG. 3). The antenna 420 may be disposed closer to a housing (e.g., the housing 310 of FIG. 3) than other components to be described below (e.g., a first substrate 430, a second substrate 440, a battery 450, a microphone 460).

According to an embodiment, the wearable electronic device 400 may include a first substrate 430. The first substrate 430 may be named a “main substrate”. The first substrate 430 may be electrically connected to the antenna 420. The first substrate 430 may be electrically connected to the second substrate 440. The first substrate 430 may be electrically connected to a battery 450. The first substrate 430 may be electrically connected to a microphone 460. The first substrate 430 may be disposed between the antenna 420 and the battery 450. The first substrate 430 may be a printed circuit board.

According to an embodiment, the wearable electronic device 400 may include a second substrate 440. The second substrate 440 may be named a “sub substrate”. The second substrate 440 may be electrically connected to the first substrate 430. The second substrate 440 may be electrically connected to the microphone 460. The second substrate 440 may extend in a direction away from the antenna 420 from the first substrate 430. The second substrate 440 may include a flexible printed circuit board. At least a portion of the second substrate 440 may extend while being bent.

According to an embodiment, the wearable electronic device 400 may include a battery 450. The battery 450 may be electrically connected to the first substrate 430. The battery 450 may supply power to a speaker (e.g., the speaker 475 of FIG. 6A) and a microphone (e.g., the microphones 461, 462, 470 of FIG. 6A). The battery 450 may be disposed between a speaker (e.g., the speaker 475 of FIG. 6A) and the first substrate 430.

According to an embodiment, the wearable electronic device 400 may include a microphone 460. The microphone 460 may be electrically connected to the second substrate 440. The microphone 460 may receive sound outside a housing (e.g., the housing 310 of FIG. 3). The microphone 460 may perform an active noise cancellation function. The plurality of microphones 460 may be disposed. The microphone 460 may include a first microphone 461 and a second microphone 462 spaced apart from each other. The first microphone 461 and the second microphone 462 may be positioned in opposite directions with the first substrate 430 therebetween.

According to an embodiment, the second substrate 440 may include a plurality of ground positions (e.g., P2, P3). For example, the second substrate 440 may have a ground position P2 positioned at a portion where the second substrate 440 and the first microphone 461 are connected. For example, the second substrate 440 may have a ground position P3 positioned at a portion where the second substrate 440 and the second microphone 462 are connected.

FIG. 5 is a view conceptually illustrating the second substrate 440 illustrated in FIG. 4 in a developed manner according to an embodiment of the disclosure.

Components described with reference to FIG. 5 may be identical in whole or part to components described with reference to FIGS. 1 to 4. Components described with reference to FIG. 5 may be identical in whole or part to components described with reference to FIGS. 6A, 6B, and 7 to 13.

Referring to FIG. 5, the second substrate 440 may include a hub 441. The hub 441 may be a portion of the second substrate 440. The hub 441 may be elongated. The hub 441 may be connected to a plurality of branch portions (e.g., 442, 443, 444, 445, 446). The hub 441 and the plurality of branch portions (e.g., 442, 443, 444, 445, 446) may be integral. The hub 441 may be named a “first body”. The plurality of branch portions (e.g., 442, 443, 444, 445, 446) may be named a “second body”.

According to an embodiment, the second substrate 440 may include branch portions 442, 443, 444, 445, 446. The branch portions 442, 443, 444, 445, 446 may extend from the hub 441. The branch portions 442, 443, 444, 445, 446 may extend in a direction crossing an extension direction of the hub 441.

According to an embodiment, the second substrate 440 may include a first branch portion 442. The first branch portion 442 may extend from the hub 441 toward a first substrate (e.g., 430 of FIG. 4). The first branch portion 442 may be electrically connected to a first substrate (e.g., 430 of FIG. 4). The plurality of branch portions 442, 443, 444, 445, 446 may include the first branch portion 442. The first branch portion 442 may include a first substrate connection portion 4421. The first substrate connection portion 4421 may form an edge of the first branch portion 442. The first substrate connection portion 4421 may be electrically connected to a first substrate (e.g., 430 of FIG. 4). The first substrate connection portion 4421 may be named a “first portion”.

According to an embodiment, the second substrate 440 may include a first ground position P1. The first ground position P1 may be positioned at the first branch portion 442. The first ground position P1 may be positioned at the first substrate connection portion 4421. The wearable electronic device 400 may include a first ground structure 492. The first ground structure 492 may be disposed at the first branch portion 442. The first ground structure 492 may be disposed at the first substrate connection portion 4421. The first ground position P1 may be positioned at the first ground structure 492. The first substrate connection portion 4421 may be a portion of the second substrate 440. The first ground structure 492 is a member connecting the first substrate 430 and the second substrate 440, and may connect the first substrate 430 and the second substrate 440 in the same manner as second and third ground structures 495, 496.

According to an embodiment, the second substrate 440 may include second branch portions 445, 446. The second branch portions 445, 446 may extend from the hub 441 toward microphones 461, 462. The second branch portions 445, 446 may be electrically connected to the microphones 461, 462. The plurality of branch portions 442, 443, 444, 445, 446 may include the second branch portions 445, 446. The second branch portions 445, 446 may include a 2-1th branch portion 445. The 2-1th branch portion 445 may be electrically connected to the first microphone 461. The second branch portions 445, 446 may include a 2-2th branch portion 446. The 2-2th branch portion 446 may be electrically connected to the second microphone 462.

According to an embodiment, the 2-1th branch portion 445 may include a first microphone connection portion 4451. The first microphone connection portion 4451 may form an edge of the 2-1th branch portion 445. The first microphone connection portion 4451 may be electrically connected to the first microphone 461. The first microphone connection portion 4451 may be named a “second portion”. The second substrate 440 may include a second ground position P2. The second ground position P2 may be positioned at the 2-1th branch portion 445. The second ground position P2 may be positioned at the first microphone connection portion 4451. The wearable electronic device 400 may include a second ground structure 495. The second ground structure 495 may be disposed at the 2-1th branch portion 445. The second ground structure 495 may be disposed at the first microphone connection portion 4451. The second ground position P2 may be positioned at the second ground structure 495. The first microphone connection portion 4451 may be a portion of the second substrate 440. The second ground structure 495 may connect the first microphone connection portion 4451 and the first microphone 461. The second ground structure 495 may include conductive gaskets 495a, 495b. The second ground structure 495 may include a clip 495c. The second ground structure 495 may be at least one of the conductive gaskets 495a, 495b or the clip 495c. The conductive gaskets 495a, 495b may be disposed between the first microphone 461 and the second substrate 440. As illustrated in FIG. 6A, one surface 495a1, 495b1 of the conductive gaskets 495a, 495b may be coupled to the first microphone 461, and the other surface 495a2, 495b2 may be coupled to the second substrate 440. As illustrated in FIG. 6A, one end 495c1 of the clip 495c may be coupled to the first microphone 461, and the other end 495c2 may be coupled to the second substrate 440. The second ground structure 495 may ground the second substrate 440 to the first microphone 461 by the above-described method. The description of the above-described grounding method of the second ground structure 495 may be equally applied to a grounding method between a third ground structure 496 and the second microphone 462.

According to an embodiment, the 2-2th branch portion 446 may include a second microphone connection portion 4461. The second microphone connection portion 4461 may form an edge of the 2-2th branch portion 446. The second microphone connection portion 4461 may be electrically connected to the second microphone 462. The second microphone connection portion 4461 may be named a “third portion”. The second substrate 440 may include a third ground position P3. The third ground position P3 may be positioned at the 2-2th branch portion 446. The third ground position P3 may be positioned at the second microphone connection portion 4461. The wearable electronic device 400 may include a third ground structure 496. The third ground structure 496 may be disposed at the 2-2th branch portion 446. The third ground structure 496 may be disposed at the second microphone connection portion 4461. The third ground position P3 may be positioned at the third ground structure 496.

According to an embodiment, the second substrate 440 may include a third branch portion 443. The third branch portion 443 may extend from the hub 441 toward a third microphone 470. The third branch portion 443 may be electrically connected to the third microphone 470. The plurality of branch portions 442, 443, 444, 445, 446 may include the third branch portion 443. The third branch portion 443 may include a third microphone connection portion 4431. The third microphone connection portion 4431 may form an edge of the third branch portion 443. The third microphone connection portion 4431 may be electrically connected to the third microphone 470.

According to an embodiment, the second substrate 440 may include a fourth branch portion 444. The plurality of branch portions 442, 443, 444, 445, 446 may include the fourth branch portion 444. The wearable electronic device 400 according to an embodiment of the disclosure may include a ground structure (not illustrated) formed at the fourth branch portion 444, and the ground structure (not illustrated) may be coupled to a metal member (not illustrated) of the wearable electronic device 400.

FIG. 6A is a cross-sectional view illustrating the wearable electronic device 400 illustrated in FIG. 4 according to an embodiment of the disclosure.

Components described with reference to FIG. 6A may be identical in whole or part to components described with reference to FIGS. 1 to 5. Components described with reference to FIG. 6A may be identical in whole or part to components described with reference to FIGS. 6B and 7 to 13.

Referring to FIG. 6A, the wearable electronic device 400 may include an antenna 420, a first substrate 430, a second substrate 440, a battery 450, a first microphone 461, and a second microphone 462. Description of the above-described components (e.g., the antenna 420, the first substrate 430, the second substrate 440, the battery 450, the first microphone 461, the second microphone 462) may be equally applied to description of components (e.g., the antenna 420, the first substrate 430, the second substrate 440, the battery 450, the first microphone 461, the second microphone 462) described with reference to FIG. 4.

According to an embodiment, the wearable electronic device 400 may include a second ground structure 495 and a third ground structure 496. Description of the above-described ground structures 495, 496 may be equally applied to description of the ground structures 495, 496 described with reference to FIG. 5.

According to an embodiment, the wearable electronic device 400 may include a second ground position P2 and a third ground position P3. Description of the above-described ground positions P2, P3 may be equally applied to description of the ground positions P2, P3 described with reference to FIG. 5.

According to an embodiment, the wearable electronic device 400 may include a speaker 475. The wearable electronic device 400 may include a third microphone 470. The wearable electronic device 400 may include an ear tip 480. The battery 450 may be disposed between the first substrate 430 and the speaker 475. On one side with respect to the battery 450, the first substrate 430, the first microphone 461, the second microphone 462, and the antenna 420 may be disposed, and on the other side with respect to the battery 450, the speaker 475, the third microphone 470, and the ear tip 480 may be disposed.

According to an embodiment, the battery 450 may include a first surface 451. The first surface 451 may be one side surface of the battery 450 facing the antenna 420 and the first substrate 430. The battery 450 may include a second surface 452. The second surface 452 may be the other side surface of the battery 450 facing the speaker 475. At least a portion of the first surface 451 may include a metal material. The second ground structure 495 may be disposed between the first microphone 461 and the first surface 451, and may contact each of the first microphone 461 and the first surface 451. At least a portion of the first microphone 461 may include a metal material, and the second ground structure 495 may contact the metal material portion of the first microphone 461. The second ground position P2 may be a position where the second ground structure 495 contacts the first microphone 461 and the first surface 451. The third ground structure 496 may be disposed between the second microphone 462 and the first surface 451, and may contact each of the second microphone 462 and the first surface 451. The third ground position P3 may be a position where the third ground structure 496 contacts the second microphone 462 and the first surface 451.

FIG. 6B is a cross-sectional view illustrating a wearable electronic device 500 according to an embodiment of the disclosure.

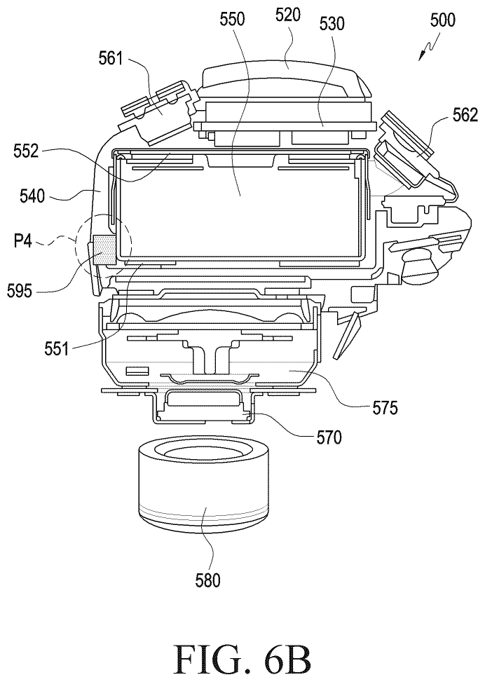

Components described with reference to FIG. 6B may be identical in whole or part to components described with reference to FIGS. 1 to 5 and 6A. Components described with reference to FIG. 6B may be identical in whole or part to components described with reference to FIGS. 7 to 13.

Referring to FIG. 6B, the wearable electronic device 500 may include an antenna 520, a first substrate 530, a second substrate 540, a battery 550, a first microphone 561, and a second microphone 562. Description of the above-described components (e.g., the antenna 520, the first substrate 530, the second substrate 540, the battery 550, the first microphone 561, the second microphone 562) may be equally applied to description of components (e.g., the antenna 420, the first substrate 430, the second substrate 440, the battery 450, the first microphone 461, the second microphone 462) described with reference to FIG. 4.

According to an embodiment, the wearable electronic device 500 may include a speaker 575. The wearable electronic device 500 may include a third microphone 570. The wearable electronic device 500 may include an ear tip 580. The battery 550 may be disposed between the first substrate 530 and the speaker 575. On one side with respect to the battery 550, the first substrate 530, the first microphone 561, the second microphone 562, and the antenna 520 may be disposed, and on the other side with respect to the battery 550, the speaker 575, the third microphone 570, and the ear tip 580 may be disposed.

According to an embodiment, the wearable electronic device 500 may include a second ground structure 595. The second ground structure 595 may connect the second substrate 540 and the battery 550. The wearable electronic device 500 may include a fourth ground position P4. The fourth ground position P4 may be positioned at a position where the second ground structure 595 is connected to the second substrate 540 and the battery 550. A portion of the second substrate 540 to which the second ground structure 595 is coupled may be named a “second portion”.

According to an embodiment, the battery 550 may include a first surface 551. The first surface 551 may be one side surface of the battery 550 facing the speaker 575. The battery 550 may include a second surface 552. The second surface 552 may be the other side surface of the battery 550 facing the antenna 520 and the first substrate 530. At least a portion of the first surface 551 may include a metal material. The second ground structure 595 may be positioned between the second substrate 540 and the first surface 551, and may contact each of the second substrate 540 and the first surface 551. The second ground structure 595 may be disposed between a side surface of the battery 550 and the second substrate 540.

FIG. 7 is a view illustrating an internal structure of a housing (e.g., the housing 310 of FIG. 3) of a wearable electronic device according to an embodiment of the disclosure.

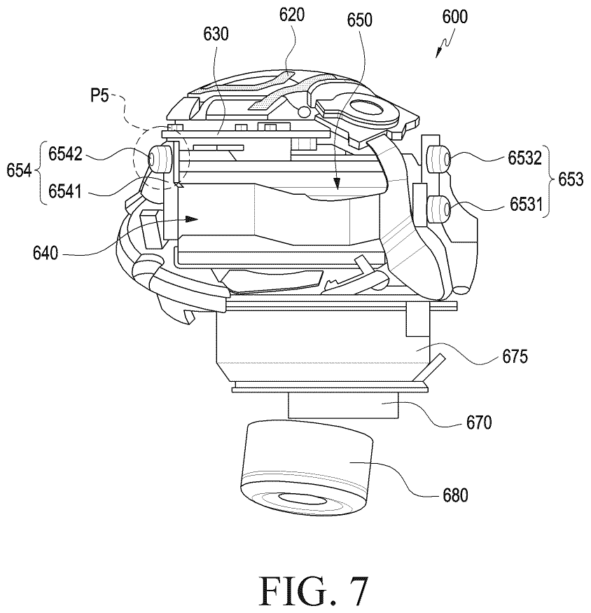

Components described with reference to FIG. 7 may be identical in whole or part to components described with reference to FIGS. 1 to 5, 6A, and 6B. Some or all of the components described with reference to FIG. 7 may be the same as all or some of the components described with reference to FIGS. 8 to 13.

Referring to FIG. 7, the wearable electronic device 600 may include an antenna 620, a first substrate 630, a second substrate 640, a battery 650, a speaker 675, a third microphone 670, and an ear tip 680. Description of the above-described components (e.g., the antenna 620, the first substrate 630, the second substrate 640, the battery 650, the speaker 675, the third microphone 670, the ear tip 680) may be equally applied to description of components (e.g., the antenna 420, the first substrate 430, the second substrate 440, the battery 450, the speaker 475, the third microphone 470, the ear tip 480) described with reference to FIGS. 1 to 5, 6A, and 6B.

According to an embodiment, the battery 650 may include a power feeding portion 653. The power feeding portion 653 may protrude toward an outside of the battery 650. The power feeding portion 653 may supply power to components of the wearable electronic device 600 (e.g., the speaker 675, the microphone 670). The power feeding portion 653 may include a first terminal 6531 and a second terminal 6532. One of the first terminal 6531 and the second terminal 6532 may provide a positive electrode (V+), and one of the first terminal 6531 and the second terminal 6532 may provide a negative electrode (V−). A line (not illustrated) may be connected to the power feeding portion 653, and the line (not illustrated) may be coupled to the power feeding portion 653 through various coupling methods (e.g., soldering).

According to an embodiment, the battery 650 may include a ground portion 654. The ground portion 654 may protrude toward an outside of the battery 650. The ground portion 654 may provide a ground structure to the second substrate 640. The ground portion 654 may include a plate 6541 and a protrusion 6542. The plate 6541 may be coupled to one side surface of the battery 650, and the protrusion 6542 may protrude from the plate 6541. The second substrate 640 may be coupled to the ground portion 654. For example, at least a portion of the second substrate 640 may be coupled to the protrusion 6542 by soldering.

According to an embodiment, the second substrate 640 may include a fifth ground position P5. For example, the second substrate 640 may include a ground position P5 at a portion where the second substrate 640 and the ground portion 654 are connected.

FIG. 8 is a view conceptually illustrating a second substrate illustrated in FIG. 7 in a developed manner according to an embodiment of the disclosure.

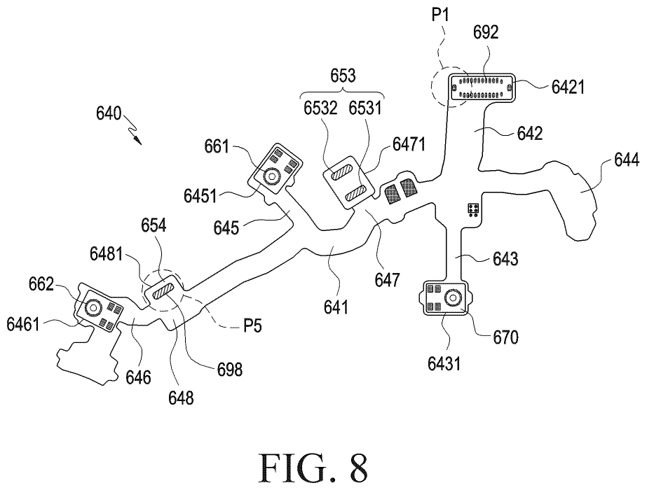

Components described with reference to FIG. 8 may be identical in whole or part to components described with reference to FIGS. 1 to 5, 6A, 6B, and 7. Some or all of the components described with reference to FIG. 8 may be the same as all or some of the components described with reference to FIGS. 9 to 13.

Referring to FIG. 8, the second substrate 640 may include a hub 641. The hub 641 may be a portion of the second substrate 640. The hub 641 may be elongated. The hub 641 may be connected to a plurality of branch portions (e.g., 642, 643, 644, 645, 646, 647, 648). The hub 641 and the plurality of branch portions (e.g., 642, 643, 644, 645, 646, 647, 648) may be integral. The hub 641 may be named a “first body”. The plurality of branch portions (e.g., 642, 643, 644, 645, 646, 647, 648) may be named a “second body”.

According to an embodiment, the second substrate 640 may include branch portions 642, 643, 644, 645, 646, 647, 648. The branch portions 642, 643, 644, 645, 646, 647, 648 may extend from the hub 641. The branch portions 642, 643, 644, 645, 646, 647, 648 may extend in a direction crossing an extension direction of the hub 641.

According to an embodiment, the second substrate 640 may include a first branch portion 642. The first branch portion 642 may extend from the hub 641 toward a first substrate (e.g., 630 of FIG. 7). The first branch portion 642 may be electrically connected to a first substrate (e.g., 630 of FIG. 7). The plurality of branch portions 642, 643, 644, 645, 646, 647, 648 may include the first branch portion 642. The first branch portion 642 may include a first substrate connection portion 6421. The first substrate connection portion 6421 may form an edge of the first branch portion 642. The first substrate connection portion 6421 may be electrically connected to a first substrate (e.g., 630 of FIG. 7). The first substrate connection portion 6421 may be named a “first portion”.

According to an embodiment, the second substrate 640 may include a first ground position P1. The first ground position P1 may be positioned at the first branch portion 642. The first ground position P1 may be positioned at the first substrate connection portion 6421. The wearable electronic device 600 may include a first ground structure 692. The first ground structure 692 may be disposed at the first branch portion 642. The first ground structure 692 may be disposed at the first substrate connection portion 6421. The first ground position P1 may be positioned at the first ground structure 692.

According to an embodiment, the second substrate 640 may include a second branch portion 648. The second branch portion 648 may extend from the hub 641 toward a ground portion 654 of the battery 650. The second branch portion 648 may be electrically connected to the ground portion 654. The plurality of branch portions 642, 643, 644, 645, 646, 647, 648 may include the second branch portion 648.

According to an embodiment, the second branch portion 648 may include a ground portion connection portion 6481. The ground portion connection portion 6481 may form an edge of the second branch portion 648. The ground portion connection portion 6481 may be electrically connected to the ground portion 654. The ground portion connection portion 6481 may be named a “second portion”. The ground portion connection portion 6481 may be coupled to the ground portion 654 through soldering. The second substrate 640 may include a fifth ground position P5. The fifth ground position P5 may be positioned at the second branch portion 648. The fifth ground position P5 may be positioned at the ground portion connection portion 6481. The wearable electronic device 600 may include a second ground structure 698. The second ground structure 698 may be disposed at the second branch portion 648. The second ground structure 698 may be disposed at the ground portion connection portion 6481. The fifth ground position P5 may be positioned at the second ground structure 698.

According to an embodiment, the second substrate 640 may include a 2-2th branch portion 647. The 2-2th branch portion 647 may extend from the hub 641 toward a power feeding portion 653 of the battery 650. The 2-2th branch portion 647 may be electrically connected to the power feeding portion 653. The plurality of branch portions 642, 643, 644, 645, 646, 647, 648 may include the 2-2th branch portion 647. The 2-2th branch portion 647 may include a power feeding portion connection portion 6471. The power feeding portion connection portion 6471 may form an edge of the 2-2th branch portion 647. The power feeding portion connection portion 6471 may be electrically connected to the power feeding portion 653. The power feeding portion connection portion 6471 may be coupled to the power feeding portion 653 through soldering.

According to an embodiment, the second substrate 640 may include a third branch portion 643. The third branch portion 643 may extend from the hub 641 toward a third microphone 670. The third branch portion 643 may be electrically connected to the third microphone 670. The plurality of branch portions 642, 643, 644, 645, 646, 647, 648 may include the third branch portion 643. The third branch portion 643 may include a third microphone connection portion 6431. The third microphone connection portion 6431 may form an edge of the third branch portion 643. The third microphone connection portion 6431 may be electrically connected to the third microphone 670.

According to an embodiment, the second substrate 640 may include a fourth branch portion 644. The plurality of branch portions 642, 643, 644, 645, 646, 647, 648 may include the fourth branch portion 644. The wearable electronic device 600 according to an embodiment of the disclosure may include a ground structure (not illustrated) formed at the fourth branch portion 644, and the ground structure (not illustrated) may be coupled to a metal member (not illustrated) of the wearable electronic device 600.

According to an embodiment, the second substrate 640 may include a fifth branch portion 645. The fifth branch portion 645 may extend from the hub 641 toward a first microphone 661. The fifth branch portion 645 may be electrically connected to the first microphone 661. The plurality of branch portions 642, 643, 644, 645, 646, 647, 648 may include the fifth branch portion 645. The fifth branch portion 645 may include a first microphone connection portion 6451. The first microphone connection portion 6451 may form an edge of the fifth branch portion 645. The first microphone connection portion 6451 may be electrically connected to the first microphone 661. Description of the first microphone 661 may be equally applied to description of the first microphone 461 described with reference to FIG. 4.

According to an embodiment, the second substrate 640 may include a sixth branch portion 646. The sixth branch portion 646 may extend from the hub 641 toward a second microphone 662. The sixth branch portion 646 may be electrically connected to the second microphone 662. The plurality of branch portions 642, 643, 644, 645, 646, 647, 648 may include the sixth branch portion 646. The sixth branch portion 646 may include a second microphone connection portion 6461. The second microphone connection portion 6461 may form an edge of the sixth branch portion 646. The second microphone connection portion 6461 may be electrically connected to the second microphone 662. Description of the second microphone 662 may be equally applied to description of the second microphone 462 described with reference to FIG. 4.

FIG. 9 is a view illustrating a battery viewed from one side according to an embodiment of the disclosure.

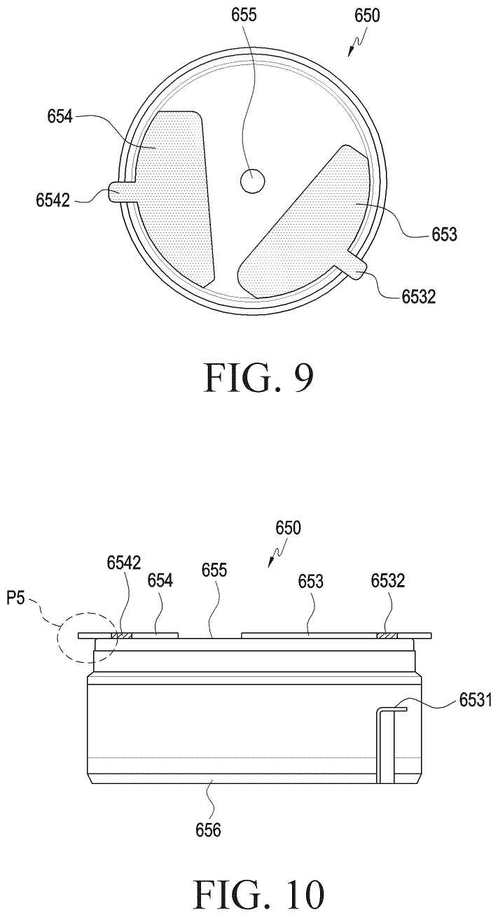

FIG. 10 is a view illustrating the battery 650 illustrated in FIG. 9 viewed from another side according to an embodiment of the disclosure.

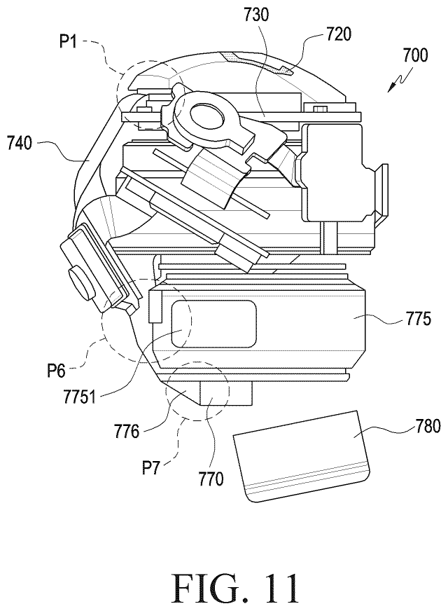

Some or all of the components described with reference to FIGS. 9 and 10 may be the same as all or some of the components described with reference to FIGS. 1 to 5, 6A, 6B, 7, and 8. Some or all of the components described with reference to FIGS. 9 and 10 may be the same as those described with reference to FIGS. 11 to 13.

Referring to FIGS. 9 and 10, the battery 650 may include a first surface 655 and a second surface 656. The first surface 655 and the second surface 656 may be positioned in opposite directions with respect to a center of the battery 650. The power feeding portion 653 and the ground portion 654 may be positioned on the first surface 655. The power feeding portion 653 and the ground portion 654 may be spaced apart from each other. The protrusion 6542 may protrude radially outward from the battery 650. The first terminal 6531 and the second terminal 6532 may protrude radially outward from the battery 650. The second terminal 6532 and the protrusion 6542 may be positioned on substantially the same plane as the first surface 655. For example, the protrusion 6542 may be positioned on the first surface 655 of the battery 650 as the negative electrode (i.e., second terminal 6532) of the power feeding portion 653 may be positioned on the first surface 655. The first terminal 6531 may be positioned between the first surface 655 and the second surface 656. The first terminal 6531 may be a positive electrode (V+), and the second terminal 6532 may be a negative electrode (V−).

FIG. 11 is a view illustrating an internal structure of a housing (e.g., the housing 310 of FIG. 3) of a wearable electronic device according to an embodiment of the disclosure.

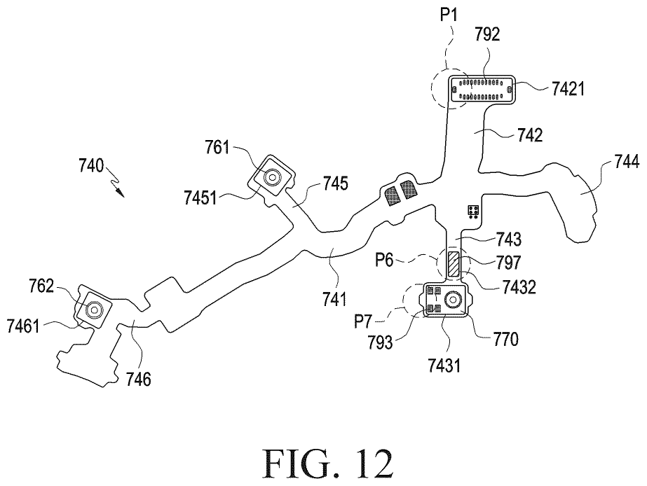

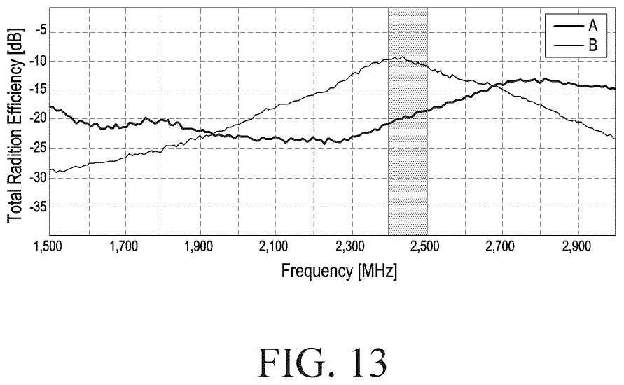

Components described with reference to FIG. 11 may be identical in whole or part to components described with reference to FIGS. 1 to 5, 6A, 6B, and 7 to 10. Some or all of the components described with reference to FIG. 11 may be the same as all or some of the components described with reference to FIGS. 12 and 13.

Referring to FIG. 11, the wearable electronic device 700 may include an antenna 720, a first substrate 730, a second substrate 740, a speaker 775, a third microphone 770, and an ear tip 780. Description of the above-described components (e.g., the antenna 720, the first substrate 730, the second substrate 740, the speaker 775, the third microphone 770, the ear tip 780) may be equally applied to description of components (e.g., the antenna 420, the first substrate 430, the second substrate 440, the speaker 475, the third microphone 470, the ear tip 480) described with reference to FIGS. 1 to 5, 6A, 6B, and 7 to 10.

According to an embodiment, the speaker 775 may include a first ground portion 7751. The first ground portion 7751 may be exposed to an outside of the speaker 775. At least a portion of the first ground portion 7751 may include a metal material. The third microphone 770 may include a second ground portion 776. The second ground portion 776 may be exposed to an outside of the third microphone 770. At least a portion of the second ground portion 776 may include a metal material.

According to an embodiment, the second substrate 740 may include a first ground position P1. The first ground position P1 may be positioned at a portion where the first substrate 730 and the second substrate 740 are coupled. The second substrate 740 may include a sixth ground position P6. For example, the second substrate 740 may include a ground position P6 at a portion where the second substrate 740 and the first ground portion 7751 of the speaker 775 are connected. For example, the second substrate 740 may include a ground position P7 at a portion where the second substrate 740 and the second ground portion 776 of the third microphone 770 are connected.

FIG. 12 is a view conceptually illustrating the second substrate 740 illustrated in FIG. 11 in a developed manner according to an embodiment of the disclosure.

Components described with reference to FIG. 12 may be identical in whole or part to components described with reference to FIGS. 1 to 5, 6A, 6B, and 7 to 11.

Referring to FIG. 12, the second substrate 740 may include a hub 741. The hub 741 may be a portion of the second substrate 740. The hub 741 may be elongated. The hub 741 may be connected to a plurality of branch portions (e.g., 742, 743, 744, 745, 746). The hub 741 and the plurality of branch portions (e.g., 742, 743, 744, 745, 746) may be integral. The hub 741 may be named a “first body”. The plurality of branch portions (e.g., 742, 743, 744, 745, 746) may be named a “second body”.

According to an embodiment, the second substrate 740 may include branch portions 742, 743, 744, 745, 746. The branch portions 742, 743, 744, 745, 746 may extend from the hub 741. The branch portions 742, 743, 744, 745, 746 may extend in a direction crossing an extension direction of the hub 741.

According to an embodiment, the second substrate 740 may include a first branch portion 742. The first branch portion 742 may extend from the hub 741 toward a first substrate (e.g., 730 of FIG. 11). The first branch portion 742 may be electrically connected to a first substrate (e.g., 730 of FIG. 11). The plurality of branch portions 742, 743, 744, 745, 746 may include the first branch portion 742. The first branch portion 742 may include a first substrate connection portion 7421. The first substrate connection portion 7421 may form an edge of the first branch portion 742. The first substrate connection portion 7421 may be electrically connected to a first substrate (e.g., 730 of FIG. 11). The first substrate connection portion 7421 may be named a “first portion”.

According to an embodiment, the second substrate 740 may include a first ground position P1. The first ground position P1 may be positioned at the first branch portion 742. The first ground position P1 may be positioned at the first substrate connection portion 7421. The wearable electronic device 700 may include a first ground structure 792. The first ground structure 792 may be disposed at the first branch portion 742. The first ground structure 792 may be disposed at the first substrate connection portion 7421. The first ground position P1 may be positioned at the first ground structure 792.

According to an embodiment, the second substrate 740 may include a second branch portion 743. The second branch portion 743 may extend from the hub 741 toward the speaker 775 and the third microphone 770. The second branch portion 743 may be electrically connected to the speaker 775 and the third microphone 770. The plurality of branch portions 742, 743, 744, 745, 746 may include the second branch portion 743.

According to an embodiment, the second branch portion 743 may include a microphone connection portion 7431. The microphone connection portion 7431 may form an edge of the second branch portion 743. The microphone connection portion 7431 may be electrically connected to the microphone 770. The microphone connection portion 7431 may be named a “second portion”. The microphone connection portion 7431 may be coupled to a second ground portion (e.g., 776 of FIG. 11) of the microphone 770 through soldering. The second substrate 740 may include a seventh ground position P7. The seventh ground position P7 may be positioned at the second branch portion 743. The seventh ground position P7 may be positioned at the microphone connection portion 7431. The wearable electronic device 700 may include a second ground structure 793. The second ground structure 793 may be disposed at the second branch portion 743. The second ground structure 793 may be disposed at the microphone connection portion 7431. The seventh ground position P7 may be positioned at the second ground structure 793.

According to an embodiment, the second branch portion 743 may include a speaker connection portion 7432. The speaker connection portion 7432 may be a portion of the second branch portion 743. The speaker connection portion 7432 may be electrically connected to a speaker (e.g., 775 of FIG. 11). The speaker connection portion 7432 may be named a “second portion”. The speaker connection portion 7432 may be coupled to a first ground portion (e.g., 7751 of FIG. 11) of the speaker 775 through soldering. The second substrate 740 may include a sixth ground position P6. The sixth ground position P6 may be positioned at the second branch portion 743. The sixth ground position P6 may be positioned at the speaker connection portion 7432. The wearable electronic device 700 may include a third ground structure 797. The third ground structure 797 may be disposed at the second branch portion 743. The third ground structure 797 may be disposed at the speaker connection portion 7432. The sixth ground position P6 may be positioned at the third ground structure 797.

According to an embodiment, the second substrate 740 may include a fourth branch portion 744. The plurality of branch portions 742, 743, 744, 745, 746 may include the fourth branch portion 744. The wearable electronic device 700 according to an embodiment of the disclosure may include a ground structure (not illustrated) formed at the fourth branch portion 744, and the ground structure (not illustrated) may be coupled to a metal member (not illustrated) of the wearable electronic device 700.

According to an embodiment, the second substrate 740 may include a fifth branch portion 745. The fifth branch portion 745 may extend from the hub 741 toward a first microphone 761. The fifth branch portion 745 may be electrically connected to the first microphone 761. The plurality of branch portions 742, 743, 744, 745, 746 may include the fifth branch portion 745. The fifth branch portion 745 may include a first microphone connection portion 7451. The first microphone connection portion 7451 may form an edge of the fifth branch portion 745. The first microphone connection portion 7451 may be electrically connected to the first microphone 761. Description of the first microphone 761 may be equally applied to description of the first microphone 461 described with reference to FIG. 4.

According to an embodiment, the second substrate 740 may include a sixth branch portion 746. The sixth branch portion 746 may extend from the hub 741 toward a second microphone 762. The sixth branch portion 746 may be electrically connected to the second microphone 762. The plurality of branch portions 742, 743, 744, 745, 746 may include the sixth branch portion 746. The sixth branch portion 746 may include a second microphone connection portion 7461. The second microphone connection portion 7461 may form an edge of the sixth branch portion 746. The second microphone connection portion 7461 may be electrically connected to the second microphone 762. Description of the second microphone 762 may be equally applied to description of the second microphone 462 described with reference to FIG. 4.

A second substrate (e.g., 440, 540, 640, 740 of FIGS. 4, 5, 6A, 6B, and 7 to 12) according to various embodiments of the disclosure may include a plurality of ground positions (e.g., P1, P2, P3, P4, P5, P6, P7 of FIGS. 4, 5, 6A, 6B, and 7 to 12), and may include a first ground position P1 connected to a first substrate (e.g., 430, 530, 630, 730 of FIGS. 4, 5, 6A, 6B, and 7 to 12). The first ground position P1 may be named a “first portion”. A second substrate (e.g., 440, 540, 640, 740 of FIGS. 4, 5, 6A, 6B, and 7 to 12) according to various embodiments of the disclosure may include a plurality of ground positions (e.g., P1, P2, P3, P4, P5, P6, P7 of FIGS. 4, 5, 6A, 6B, and 7 to 12), and may include a second ground position (e.g., P2, P3, P4, P5, P6, P7 of FIGS. 4, 5, 6A, 6B, and 7 to 12) spaced apart from the first ground position P1 in a direction in which the second substrate (e.g., 440, 540, 640, 740 of FIGS. 4, 5, 6A, 6B, and 7 to 12) extends.

The second ground position (e.g., P2, P3, P4, P5, P6, P7 of FIGS. 4, 5, 6A, 6B, and 7 to 12) may be named a “second portion”. A plurality of second ground positions may be positioned. For example, the second ground position may be positioned at a position illustrated in FIG. 5 (e.g., P2, P3), and may simultaneously be positioned at a position illustrated in FIG. 8 (e.g., P5) or a position illustrated in FIG. 12 (e.g., P6, P7).

A wearable electronic device (e.g., 400, 500, 600, 700 of FIGS. 4, 5, 6A, 6B, and 7 to 12) according to various embodiments of the disclosure may include a first ground structure (e.g., 492, 692, 792 of FIGS. 4, 5, 6A, 6B, and 7 to 12) and a second ground structure (e.g., 495, 496, 698, 793, 797 of FIGS. 4, 5, 6A, 6B, and 7 to 12). The second ground structure (e.g., 495, 496, 698, 793, 797 of FIGS. 4, 5, 6A, 6B, and 7 to 12) may be disposed at a second branch portion (e.g., 445, 446, 648, 743 of FIGS. 4, 5, 6A, 6B, and 7 to 12). The second ground structure (e.g., 495, 496, 698, 793, 797 of FIGS. 4, 5, 6A, 6B, and 7 to 12) may include a metal material and may be coupled to a second branch portion (e.g., 445, 446, 648, 743 of FIGS. 4, 5, 6A, 6B, and 7 to 12) through soldering. The second ground structure (e.g., 495, 496, 698, 793, 797 of FIGS. 4, 5, 6A, 6B, and 7 to 12) may be a conductive gasket, a C-Clip, a POGO PIN, or a ZIP connector.

FIG. 13 is a graph comparing antenna performance of a wearable electronic device (e.g., 400, 500, 600, 700 of FIGS. 4, 5, 6A, 6B, and 7 to 12) with a comparative example according to an embodiment of the disclosure.

Components described with reference to FIG. 13 may be identical in whole or part to components described with reference to FIGS. 1 to 5, 6A, 6B, and 7 to 12.

Referring to FIG. 13, line A illustrates antenna performance according to a comparative example, and line B illustrates antenna performance of an antenna (e.g., 420 illustrated in FIG. 4) according to an embodiment of the disclosure (e.g., 400 illustrated in FIG. 4). The horizontal axis represents frequency, and the vertical axis represents radiation efficiency of an antenna. According to the graph of FIG. 13, a wearable electronic device according to various embodiments of the disclosure may enhance antenna performance by reducing parasitic resonance in a second substrate by grounding the second substrate at various positions through a second ground structure in addition to a first ground structure. For example, it may be identified that radiation performance of line B is higher than radiation performance of line A in a frequency band of 2400˜2500 megahertz (MHz).

A wearable electronic device includes a housing having components such as a speaker, a battery, and a microphone disposed therein, and an antenna transmitting/receiving a signal outside the housing. The wearable electronic device includes a main substrate electrically connected to an antenna, and a sub substrate (e.g., a flexible circuit board) connecting the main substrate and other components (e.g., a speaker, a battery, a microphone). The sub substrate extends lengthwise from the main substrate and generates parasitic resonance that interferes with a signal of an antenna in an extension direction.

An object of the disclosure may be to reduce parasitic resonance generated along an extension direction of a substrate.

An object of the disclosure may be to optimize arrangement positions of ground structures by utilizing components of a wearable electronic device.

Objects of the disclosure are not limited to those mentioned, but may rather be diverse without departing from the spirit and scope of the disclosure.

An electronic device according to various embodiments of the disclosure may reduce generation of parasitic resonance in a second substrate by forming a plurality of ground positions along an extension direction of the second substrate.

An electronic device according to various embodiments of the disclosure may ground a second substrate to components such as a microphone, a battery, and a speaker.

Effects obtainable from the disclosure are not limited to the above-mentioned effects, and other effects not mentioned may be apparent to one of ordinary skill in the art from the following description.

A wearable electronic device (e.g., 300; 400; 500; 600; 700 of FIGS. 4, 5, 6A, 6B, and 7 to 12) according to an embodiment of the disclosure may include a housing 310.

The wearable electronic device (e.g., 300; 400; 500; 600; 700 of FIGS. 4, 5, 6A, 6B, and 7 to 12) according to an embodiment of the disclosure may include an antenna (e.g., 420; 520; 620; 720 of FIGS. 4, 5, 6A, 6B, and 7 to 12) configured to receive a signal outside the housing (e.g., 310 of FIG. 3).

The wearable electronic device (e.g., 300; 400; 500; 600; 700 of FIGS. 4, 5, 6A, 6B, and 7 to 12) according to an embodiment of the disclosure may include a battery (e.g., 450; 550; 650; 750 of FIGS. 4, 5, 6A, 6B, and 7 to 12) disposed inside the housing (e.g., 310 of FIG. 3) and spaced apart from the antenna (e.g., 420; 520; 620; 720 of FIGS. 4, 5, 6A, 6B, and 7 to 12).

The wearable electronic device (e.g., 300; 400; 500; 600; 700 of FIGS. 4, 5, 6A, 6B, and 7 to 12) according to an embodiment of the disclosure may include a speaker (e.g., 475; 575; 675; 775 of FIGS. 4, 5, 6A, 6B, and 7 to 12) disposed inside the housing (e.g., 310 of FIG. 3) and spaced apart from the antenna (e.g., 420; 520; 620; 720 of FIGS. 4, 5, 6A, 6B, and 7 to 12).

The wearable electronic device (e.g., 300; 400; 500; 600; 700 of FIGS. 4, 5, 6A, 6B, and 7 to 12) according to an embodiment of the disclosure may include a first substrate (e.g., 430; 530; 630; 730 of FIGS. 4, 5, 6A, 6B, and 7 to 12) electrically connected to the antenna (e.g., 420; 520; 620; 720 of FIGS. 4, 5, 6A, 6B, and 7 to 12).

The wearable electronic device (e.g., 300; 400; 500; 600; 700 of FIGS. 4, 5, 6A, 6B, and 7 to 12) according to an embodiment of the disclosure may include a second substrate (e.g., 440; 540; 640; 740 of FIGS. 4, 5, 6A, 6B, and 7 to 12) extending from a first portion (e.g., 4421; 5421; 6421; 7421 of FIGS. 4, 5, 6A, 6B, and 7 to 12) connected to the first substrate (e.g., 430; 530; 630; 730 of FIGS. 4, 5, 6A, 6B, and 7 to 12) and connected to the speaker (e.g., 475; 575; 675; 775 of FIGS. 4, 5, 6A, 6B, and 7 to 12) or the battery (e.g., 450; 550; 650; 750 of FIGS. 4, 5, 6A, 6B, and 7 to 12), and including a second portion (e.g., 4451; 4461; 6481; 7431; 7432 of FIGS. 4, 5, 6A, 6B, and 7 to 12) formed at a position extending from the first portion (e.g., 4421; 5421; 6421; 7421 of FIGS. 4, 5, 6A, 6B, and 7 to 12).

The wearable electronic device (e.g., 300; 400; 500; 600; 700 of FIGS. 4, 5, 6A, 6B, and 7 to 12) according to an embodiment of the disclosure may include a first ground structure (e.g., 492; 592; 692; 792 of FIGS. 4, 5, 6A, 6B, and 7 to 12) disposed at the first portion (e.g., 4421; 5421; 6421; 7421 of FIGS. 4, 5, 6A, 6B, and 7 to 12) of the second substrate (e.g., 440; 540; 640; 740 of FIGS. 4, 5, 6A, 6B, and 7 to 12).

The wearable electronic device (e.g., 300; 400; 500; 600; 700 of FIGS. 4, 5, 6A, 6B, and 7 to 12) according to an embodiment of the disclosure may include a second ground structure (e.g., 495; 496; 595; 698; 793; 797 of FIGS. 4, 5, 6A, 6B, and 7 to 12) disposed at the second portion (e.g., 4451; 4461; 6481; 7431; 7432 of FIGS. 4, 5, 6A, 6B, and 7 to 12) of the second substrate (e.g., 440; 540; 640; 740 of FIGS. 4, 5, 6A, 6B, and 7 to 12).

The second portion (e.g., 4451, 4461 of FIGS. 4, 5, and 6A) of the second substrate (e.g., 440 of FIGS. 4, 5, and 6A) according to an embodiment of the disclosure may be spaced apart from the first portion (e.g., 4421 of FIGS. 4, 5, and 6A) in a direction in which the second substrate (e.g., 440 of FIGS. 4, 5, and 6A) extends.

The second substrate (e.g., 440 of FIGS. 4, 5, and 6A) according to an embodiment of the disclosure may extend at least partially in a direction away from the antenna (e.g., 420 of FIGS. 4, 5, and 6A).

The second substrate (e.g., 440 of FIGS. 4, 5, and 6A) according to an embodiment of the disclosure may have an extension length from the first portion (e.g., 4421 of FIGS. 4, 5, and 6A) to the second portion (e.g., 4451 of FIGS. 4, 5, and 6A).

The second substrate (e.g., 440 of FIGS. 4, 5, and 6A) according to an embodiment of the disclosure may include a hub (e.g., 441 of FIGS. 4, 5, and 6A) extending at least partially in a direction away from the antenna (e.g., 420 of FIGS. 4, 5, and 6A).

The second substrate (e.g., 440 of FIGS. 4, 5, and 6A) according to an embodiment of the disclosure may include a plurality of branch portions (e.g., 442, 443, 444, 445, 446 of FIGS. 4, 5, and 6A) connected to the hub (e.g., 441 of FIGS. 4, 5, and 6A).

The first portion (e.g., 4421 of FIGS. 4, 5, and 6A) and the second portion (e.g., 4451, 4461 of FIGS. 4, 5, and 6A) according to an embodiment of the disclosure may be spaced apart from each other in a direction in which the hub (e.g., 441 of FIGS. 4, 5, and 6A) extends.

The wearable electronic device (e.g., 400 of FIG. 4) according to an embodiment of the disclosure may include a microphone (e.g., 460 of FIGS. 4, 5, and 6A) spaced apart from the antenna (e.g., 420 of FIGS. 4, 5, and 6A) and electrically connected to the second substrate (e.g., 440 of FIGS. 4, 5, and 6A).

The second ground structure (e.g., 495, 496 of FIGS. 4, 5, and 6A) according to an embodiment of the disclosure may connect the second substrate (e.g., 440 of FIGS. 4, 5, and 6A) and the microphone (e.g., 460 of FIGS. 4, 5, and 6A).

The microphone (e.g., 460 of FIGS. 4, 5, and 6A) according to an embodiment of the disclosure may include a first microphone (e.g., 461 of FIGS. 4, 5, and 6A) connected to the second ground structure (e.g., 495 of FIGS. 4, 5, and 6A).

The microphone (e.g., 460 of FIGS. 4, 5, and 6A) according to an embodiment of the disclosure may include a second microphone (e.g., 462 of FIGS. 4, 5, and 6A) spaced apart from the first microphone (e.g., 461 of FIGS. 4, 5, and 6A).

The wearable electronic device (e.g., 400 of FIGS. 4, 5, and 6A) according to an embodiment of the disclosure may include a third ground structure (e.g., 496 of FIGS. 4, 5, and 6A) connecting the second substrate (e.g., 440 of FIGS. 4, 5, and 6A) and the second microphone (e.g., 462 of FIGS. 4, 5, and 6A).

The microphone (e.g., 460 of FIGS. 4, 5, and 6A) according to an embodiment of the disclosure may include a first microphone (e.g., 461 of FIGS. 4, 5, and 6A) and a second microphone (e.g., 462 of FIGS. 4, 5, and 6A) spaced apart from each other with the first substrate (e.g., 430 of FIGS. 4, 5, and 6A) therebetween.

The second substrate (e.g., 440 of FIGS. 4, 5, and 6A) according to an embodiment of the disclosure may include a 2-1th branch portion (e.g., 4451 of FIGS. 4, 5, and 6A) connected to the first microphone (e.g., 461 of FIGS. 4, 5, and 6A).

The second substrate (e.g., 440 of FIGS. 4, 5, and 6A) according to an embodiment of the disclosure may include a 2-2th branch portion (e.g., 4461 of FIGS. 4, 5, and 6A) connected to the second microphone (e.g., 462 of FIGS. 4, 5, and 6A).

The battery (e.g., 450 of FIGS. 4, 5, and 6A) according to an embodiment of the disclosure may include a first surface (e.g., 451 of FIGS. 4, 5, and 6A) facing the microphone (e.g., 461 of FIGS. 4, 5, and 6A).

The second ground structure (e.g., 495 of FIGS. 4, 5, and 6A) according to an embodiment of the disclosure may be connected to the second substrate (e.g., 440 of FIGS. 4, 5, and 6A) between the first surface (e.g., 451 of FIGS. 4, 5, and 6A) of the battery (e.g., 450 of FIGS. 4, 5, and 6A) and the microphone (e.g., 461 of FIGS. 4, 5, and 6A).

The second ground structure (e.g., 698 of FIGS. 7 to 10) according to an embodiment of the disclosure may connect the second substrate (e.g., 640 of FIGS. 7 to 10) and the battery (e.g., 650 of FIGS. 7 to 10).

The battery (e.g., 650 of FIGS. 7 to 10) according to an embodiment of the disclosure may include a power feeding portion (e.g., 653 of FIGS. 7 to 10) including a positive electrode (e.g., second terminal 6531 of FIGS. 7 to 10) and a negative electrode (e.g., 6532 of FIGS. 7 to 10).

The battery (e.g., 650 of FIGS. 7 to 10) according to an embodiment of the disclosure may include a ground portion (e.g., 654 of FIGS. 7 to 10) spaced apart from the power feeding portion (e.g., 653 of FIGS. 7 to 10) and coupled to the second ground structure (e.g., 698 of FIGS. 7 to 10).

The ground portion (e.g., 654 of FIGS. 7 to 10) according to an embodiment of the disclosure may include a protrusion (e.g., 6542 of FIGS. 7 to 10) coupled to the second ground structure (e.g., 698 of FIGS. 7 to 10) and positioned on a surface (e.g., 655 of FIGS. 7 to 10) of the battery (e.g., 650 of FIGS. 7 to 10) that is the same as the negative electrode (e.g., 6532 of FIGS. 7 to 10) of the power feeding portion (e.g., 653 of FIGS. 7 to 10).

The wearable electronic device (e.g., 700 of FIGS. 11 and 12) according to an embodiment of the disclosure may include an ear tip (e.g., 780 of FIGS. 11 and 12) spaced apart from the speaker (e.g., 775 of FIGS. 11 and 12).

The wearable electronic device (e.g., 700 of FIGS. 11 and 12) according to an embodiment of the disclosure may include a first microphone (e.g., 761 of FIGS. 11 and 12) positioned between the antenna (e.g., 720 of FIGS. 11 and 12) and the speaker (e.g., 775 of FIGS. 11 and 12) and receiving sound outside the housing (e.g., 310 of FIG. 3).

The wearable electronic device (e.g., 700 of FIGS. 11 and 12) according to an embodiment of the disclosure may include a second microphone (e.g., 762 of FIGS. 11 and 12) positioned between the antenna (e.g., 720 of FIGS. 11 and 12) and the speaker (e.g., 775 of FIGS. 11 and 12) and spaced apart from the first microphone (e.g., 761 of FIGS. 11 and 12).

The wearable electronic device (e.g., 700 of FIGS. 11 and 12) according to an embodiment of the disclosure may include a third microphone (e.g., 770 of FIGS. 11 and 12) positioned between the speaker (e.g., 775 of FIGS. 11 and 12) and the ear tip (e.g., 780 of FIGS. 11 and 12) and receiving sound outside the housing (e.g., 310 of FIG. 3).

The second ground structure (e.g., 793 of FIGS. 11 and 12) according to an embodiment of the disclosure may connect the second substrate (e.g., 740 of FIGS. 11 and 12) and the third microphone (e.g., 770 of FIGS. 11 and 12).

The wearable electronic device (e.g., 700 of FIGS. 11 and 12) according to an embodiment of the disclosure may include a third ground structure (e.g., 797 of FIGS. 11 and 12) connecting the speaker (e.g., 775 of FIGS. 11 and 12) and the second substrate (e.g., 740 of FIGS. 11 and 12).

The second substrate (e.g., 740 of FIGS. 11 and 12) according to an embodiment of the disclosure may include a second branch portion (e.g., 743 of FIGS. 11 and 12) extending toward the speaker (e.g., 775 of FIGS. 11 and 12) and the third microphone (e.g., 770 of FIGS. 11 and 12) and including a speaker connection portion (e.g., 7432 of FIGS. 11 and 12) connected to the speaker (e.g., 775 of FIGS. 11 and 12) and a microphone connection portion (e.g., 7431 of FIGS. 11 and 12) connected to the third microphone (e.g., 770 of FIGS. 11 and 12).

The wearable electronic device (e.g., 400 of FIGS. 4, 5, and 6A) according to an embodiment of the disclosure may include a housing (e.g., 310 of FIG. 3).

The wearable electronic device (e.g., 400 of FIGS. 4, 5, and 6A) according to an embodiment of the disclosure may include an antenna (e.g., 420 of FIGS. 4, 5, and 6A) configured to receive a signal outside the housing (e.g., 310 of FIG. 3).

The wearable electronic device (e.g., 400 of FIGS. 4, 5, and 6A) according to an embodiment of the disclosure may include a microphone (e.g., 460 of FIGS. 4, 5, and 6A) disposed inside the housing (e.g., 310 of FIG. 3) and spaced apart from the antenna (e.g., 420 of FIGS. 4, 5, and 6A).

The wearable electronic device (e.g., 400 of FIGS. 4, 5, and 6A) according to an embodiment of the disclosure may include a first substrate (e.g., 430 of FIGS. 4, 5, and 6A) electrically connected to the antenna (e.g., 420 of FIGS. 4, 5, and 6A).

The wearable electronic device (e.g., 400 of FIGS. 4, 5, and 6A) according to an embodiment of the disclosure may include a second substrate (e.g., 440 of FIGS. 4, 5, and 6A) extending from a first portion (e.g., 4421 of FIGS. 4, 5, and 6A) connected to the first substrate (e.g., 430 of FIGS. 4, 5, and 6A), and having a second portion (e.g., 4451, 4461 of FIGS. 4, 5, and 6A) connected to the microphone (e.g., 460 of FIGS. 4, 5, and 6A) formed at a position extending from the first portion (e.g., 4421 of FIGS. 4, 5, and 6A).

The wearable electronic device (e.g., 400 of FIGS. 4, 5, and 6A) according to an embodiment of the disclosure may include a first ground structure (e.g., 492 of FIGS. 4, 5, and 6A) disposed at the first portion (e.g., 4421 of FIGS. 4, 5, and 6A) of the second substrate (e.g., 440 of FIGS. 4, 5, and 6A).

The wearable electronic device (e.g., 400 of FIGS. 4, 5, and 6A) according to an embodiment of the disclosure may include a second ground structure (e.g., 495, 496 of FIGS. 4, 5, and 6A) disposed at the second portion (e.g., 4451, 4461 of FIGS. 4, 5, and 6A) of the second substrate (e.g., 440 of FIGS. 4, 5, and 6A).

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a housing;
an antenna configured to transmit or receive a signal outside the housing;
a battery disposed inside the housing and spaced apart from the antenna;
a speaker disposed inside the housing and spaced apart from the antenna;
a first substrate electrically connected to the antenna;
a second substrate extending from a first portion connected to the first substrate and connected to the speaker or the battery, and including a second portion formed at a position extending from the first portion;
a first ground structure disposed at the first portion of the second substrate; and
a second ground structure disposed at the second portion of the second substrate.

2. The wearable electronic device of claim 1, wherein the second portion of the second substrate is spaced apart from the first portion in a direction in which the second substrate extends.

3. The wearable electronic device of claim 1, wherein the second substrate has an extension length from the first portion to the second portion.

4. The wearable electronic device of claim 1, wherein the second substrate includes:
a hub having an extension length in a direction from the first portion toward the second portion; and
a plurality of branch portions connected to the hub.

5. The wearable electronic device of claim 4, wherein the first portion and the second portion are spaced apart from each other in a direction in which the hub extends.

6. The wearable electronic device of claim 1, further comprising:
a microphone spaced apart from the antenna and electrically connected to the second substrate,
wherein the second ground structure connects the second substrate and the microphone.

7. The wearable electronic device of claim 6,
wherein the microphone includes:
a first microphone connected to the second ground structure; and
a second microphone spaced apart from the first microphone, and
wherein the wearable electronic device further comprises a third ground structure connecting the second substrate and the second microphone.

8. The wearable electronic device of claim 6,
wherein the microphone includes:
a first microphone; and
a second microphone spaced apart from each other with the first substrate therebetween, and
wherein the second substrate includes:
a 2-1th branch portion connected to the first microphone; and
a 2-2th branch portion connected to the second microphone.

9. The wearable electronic device of claim 8,
wherein the battery includes:
a first surface facing the first microphone; and
wherein the second ground structure is connected to the second substrate between the first surface of the battery and the first microphone.

10. The wearable electronic device of claim 1, wherein the second ground structure connects the second substrate and the battery.

11. The wearable electronic device of claim 10, wherein the battery includes:
a power feeding portion including a positive electrode and a negative electrode; and
a ground portion spaced apart from the power feeding portion and coupled to the second ground structure.

12. The wearable electronic device of claim 11, wherein the ground portion includes:
a protrusion coupled to the second ground structure and positioned on a same surface of the battery as the negative electrode of the power feeding portion.

13. The wearable electronic device of claim 1, further comprising:
an ear tip spaced apart from the speaker;
a first microphone positioned between the antenna and the speaker and configured to receive sound outside the housing;
a second microphone positioned between the antenna and the speaker and spaced apart from the first microphone; and
a third microphone positioned between the speaker and the ear tip and configured to receive sound outside the housing,
wherein the second ground structure connects the second substrate and the third microphone.

14. The wearable electronic device of claim 13, further comprising:
a third ground structure connecting the speaker and the second substrate.

15. The wearable electronic device of claim 13, wherein the second substrate includes:
a second branch portion extending toward the speaker and the third microphone and including a speaker connection portion connected to the speaker and a microphone connection portion connected to the third microphone.

16. A wearable electronic device comprising:
a housing;
an antenna configured to transmit or receive a signal outside the housing;
a microphone disposed inside the housing and spaced apart from the antenna;
a first substrate electrically connected to the antenna;
a second substrate extending from a first portion connected to the first substrate, and having a second portion connected to the microphone formed at a position extending from the first portion;
a first ground structure disposed at the first portion of the second substrate; and
a second ground structure disposed at the second portion of the second substrate.

17. The wearable electronic device of claim 16, wherein the second portion of the second substrate is spaced apart from the first portion in a direction in which the second substrate extends.

18. The wearable electronic device of claim 16, wherein the second substrate has an extension length from the first portion to the second portion.

19. The wearable electronic device of claim 16, wherein the second substrate includes:
a hub having an extension length in a direction from the first portion toward the second portion; and
a plurality of branch portions connected to the hub.

20. The wearable electronic device of claim 19, wherein the first portion and the second portion are spaced apart from each other in a direction in which the hub extends.
